(19) United States
(12) Patent Application Publication
(10) Pub. No.: US 2025/0020539 A1
(43) Pub. Date: Jan. 16, 2025

(54) TRIM EXCITATION DEVICE

(71) Applicants: Shafeeq Ali Kasiemkhan, Lelystad (NL); Jelmer Gerhard Van Vilsteren, Zwolle (NL); Casimir Corstiaan Wijbrand Van Der Post, Amsterdam (NL)

(72) Inventors: Shafeeq Ali Kasiemkhan, Lelystad (NL); Jelmer Gerhard Van Vilsteren, Zwolle (NL); Casimir Corstiaan Wijbrand Van Der Post, Amsterdam (NL)

(21) Appl. No.: 18/765,610

(22) Filed: Jul. 8, 2024

(30) Foreign Application Priority Data
Jul. 12, 2023 (EP) 23185030.6

(51) Int. Cl. G01M 9/04

(52) U.S. Cl. CPC G01M 9/04

(57) ABSTRACT

A trim excitation device comprises an eccentric drive pin that moves back and forth in a drive channel of a transfer member. A link member is connected to the transfer member at one end and at an opposite end to an object. The link member defines a longitudinal direction extending between its ends. A guide moves the transfer member back-and-forth substantially perpendicular to a drive channel axis. The guide and transfer member rotate to a first rotational position, where the drive channel axis extends substantially perpendicularly to the longitudinal direction of the link member, and where the transfer member is movable back-and-forth substantially in the longitudinal direction of the link member. In a second rotational position, the drive channel axis extends substantially in the longitudinal direction of the link member and the transfer member is movable back-and-forth substantially perpendicularly to the longitudinal direction of the link member.

### CROSS-REFERENCE TO RELATED APPLICATION

The present application is based on and claims the benefit of European patent application Serial No. 23185030.6, filed Jul. 12, 2023, the content of which is hereby incorporated by reference in its entirety.

### BACKGROUND

The discussion below is merely provided for general background information and is not intended to be used as an aid in determining the scope of the claimed subject matter.

The invention relates to a trim excitation device, comprising a rotatable drive shaft, an eccentric drive pin mounted eccentrically on said drive shaft, which eccentric drive pin engages a drive channel of a transfer member and is movable back and forth in said drive channel in the direction of a drive channel axis, wherein the transfer member is connected to a first end of a link member of which an opposite second end, directly or indirectly, can be connected to an object to be excited, and wherein the link member defines a longitudinal direction extending between its first and second ends, wherein the transfer member by means of a guiding mechanism is movable back-and-forth in a direction substantially perpendicular to the drive channel axis.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in deter-mining the scope of the claimed subject matter. The claimed subject matter is not limited to implementations that solve any or all disadvantages noted in the Background.

A trim excitation device is configured such that a guide/guiding mechanism and transfer member are rotatable for assuming a desired rotational position between and including a first rotational position in which the drive channel axis extends substantially perpendicularly to the longitudinal direction of the link member and in which the transfer member by means of the guiding mechanism is movable back-and-forth substantially in the longitudinal direction of the link member, and a second rotational position in which the drive channel axis extends substantially in the longitudinal direction of the link member and in which the transfer member by means of the guiding mechanism is movable back-and-forth substantially perpendicularly to the longitudinal direction of the link member. By means of such a trim excitation device a rotational movement of the eccentric pin is transformed into a substantially linear back-and-forth movement of the link member which is transferred to the object.

In the first rotational position of the guiding mechanism and transfer member, the rotation of the eccentric drive pin causes the transfer member to move back-and-forth in the longitudinal direction of the link member which, as a result, also will move longitudinally. This will lead to a corresponding excitation of the object. In the second rotational position of the guiding mechanism and transfer member however, the rotation of the eccentric drive pin causes the transfer member to move back-and-forth substantially perpendicularly to the longitudinal direction of the link member which, as a result, at its first end will move laterally without any substantial longitudinal movement of the link member. Thus, in said second rotational position the object will not be excited.

In positions between the first and second rotational positions the object will be excited in an amount between zero excitation and maximum excitation, depending on the rotational position of the guiding mechanism and transfer member.

Thus, by choosing the rotational position (for example the angle of rotation starting from the first rotational position), the magnitude of the excitation may be selected.

In one embodiment, the guiding mechanism and the transfer member are mounted on a disc member which is mounted rotatably in a stationary support. This makes the process of rotating the guiding assembly and transfer member easy.

It is conceivable that the disc member (and thus the transfer member), for assuming a desired rotational position, is driven by a drive actuator.

For example, in one embodiment, the disc member is provided with a circumferential toothing, wherein the drive actuator includes a drive gear mounted on the stationary support, for example a drive gear driven by an electric motor, engaging the toothing. Activation of the drive gear then will lead to the required rotation of the disc member (and thus a corresponding rotation of the guiding assembly and transfer member) towards a desired new rotational position which corresponds with a required amount of excitation.

As an alternative the disc member may be biased towards one of its first and second rotational positions, wherein the drive actuator includes a drive cable or similar member, for example driven by a linear actuator, attached to the disc member for moving it towards the other of its first and second rotational positions (or any intermediate rotational position).

The guiding mechanism may be a mechanical guide. However, for limiting or altogether preventing any hysteresis effect, in one embodiment the guiding mechanism includes a spring assembly to which the transfer member is attached, and which only allows said back-and-forth movement of the transfer member in said direction substantially perpendicular to the drive channel axis. Such a spring assembly, for example, may comprise a spring with spring parts extending in a zig-zag manner.

In one embodiment of the trim excitation device, the spring assembly carries a hub, wherein the transfer member is provided with a transfer member pin engaging in the hub. Thus, the transfer member in a constructively convenient manner is connected to the spring member.

In such an embodiment it further is conceivable that also the first end of the link member is connected to the transfer member pin. As a result, the link member is securely connected to the transfer member, such that any movement of latter is transferred to the link member. It is conceivable, for example, that the transfer member pin not only engages the hub, but also engages one (or more) holes in the link member.

In one embodiment, the disc member and transfer member are provided with an assembly of cooperating pin and elongated slot for transferring a rotational movement of the disc to the transfer member while allowing a back-and-forth movement of the transfer member relative to the disc member. Of course, it is required that a rotation of the disc member (for rotating the guiding assembly) should be accompanied by a corresponding rotation of the transfer member. The use of a pin and elongated slot achieves this goal, whereas specifically the use of the elongated slot allows a limited sliding motion of the pin in the elongated slot when the transfer member (as a result of a rotation of the eccentric drive pin) moves back-and-forth (which motion will occur relative to the disc member).

In a specific embodiment the disc member is provided with the pin, whereas the transfer member is provided with the elongated slot.

In one embodiment of the trim excitation device, the second end of the link member is connected to a first end of a pivot arm that extends non parallel to the longitudinal direction of the link member, preferably substantially perpendicularly thereto, and that has a second end to be connected, directly or indirectly, to the object to be excited and that pivots around a pivot axis, wherein the position of the pivot axis is adjustable.

Apart from allowing to choose an amount of excitation by means of an appropriate choice of the rotational position of the guiding assembly and transfer member, an adjustment of the position of the pivot axis allows to choose the starting point of such an excitation, or in other words allows a trimming operation.

Specifically, it is conceivable that the position of the pivot axis of the pivot arm is adjustable in a direction substantially in parallel to the longitudinal direction of the link member (optimizing the effect of such an adjustment), wherein preferably the position of the pivot axis is adjustable by means of a trim motor, for example an electric trim motor.

In such an embodiment it is possible that the second end of the pivot arm is connected to an output link to be connected to the object to be excited. But it is possible too, that the pivot arm is directly connected to the object.

By changing the rotational position of the guiding assembly and transfer member as described above, the amount of excitation may be varied between zero and a maximum value. Said maximum value, mainly, is determined by the eccentricity of the eccentric drive pin. Thus, in an embodiment in which the eccentricity of the eccentric drive pin is adjustable and/or wherein the eccentric drive pin can be replaced by an eccentric drive pin with a different eccentricity, the maximum amount of excitation achievable may be changed.

The trim excitation device may be used in situations in which the object to be excited is (a scale model of) an aeronautical part, such as a rotor blade of a helicopter, and which, for example has to be tested in a wind tunnel. According to one state of the art, hydraulic actuators were used for such an application, which however lack sufficient precision, and which are often very large, heavy, and cumbersome and have a limited operating range. The present trim excitation device, however, is of a very lightweight construction, has an extended operating range, is very precise, and is very reliable and allows to easily change a number of characteristics of the excitation (among which frequency, amplitude, and trim, i.e. setting the maximum/zero value). It further has the advantage of offering an excitation with a sinus shape.

### BRIEF DESCRIPTION OF THE DRAWINGS

Hereinafter aspects of the invention will be elucidated while referring to the drawings, in which:

FIGS. 1 and 2 show different frontal views of a trim excitation device;

FIGS. 3 and 4 show perspective exploded views from opposite sides of part of the trim excitation device;

FIG. 5 shows different views of a transfer member;

FIG. 6 shows a disc member, and

FIGS. 7 and 8 schematically illustrate a disc member with transfer member in different rotational positions for explaining the operation of the device.

### DETAILED DESCRIPTION OF ILLUSTRATIVE EMBODIMENTS

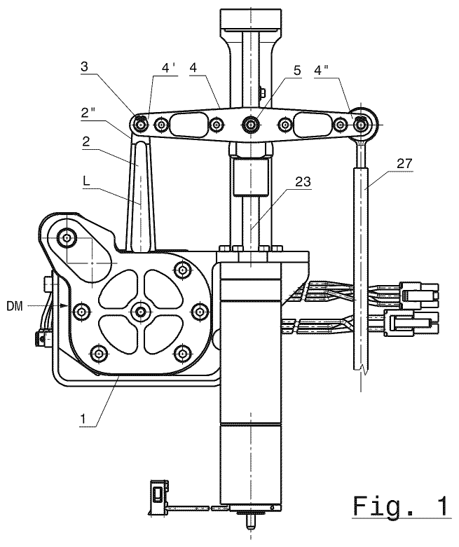

Referring firstly to FIGS. 1 and 2, a frontal view of an embodiment of a trim excitation device is illustrated, wherein FIG. 1 illustrates said device in an operative state with a cover 1 on a part of said device, whereas in the illustration according to FIG. 2 said cover 1 has been removed for showing some interior parts of the device.

An important part of the device is defined by a drive module DM which will be explained in more detail later while referring to the remaining figures and which, essentially, is used for driving a link member 2 which has a first end 2′ cooperating with the drive module DM and which has a second end 2″ connected (e.g. by means of a first pivot 3) to a first end 4′ of a pivot arm 4. The pivot arm 4 is mounted for a pivotal motion around a pivot axis 5. An opposite second end 4″ of the pivot arm 4 may, directly or indirectly (using any kind of appropriate connecting member not illustrated) be connected to an object to be excited by the trim excitation device.

In operation the drive module DM of the device is capable of moving the link member 2 back-and-forth in a longitudinal direction L of the link member 2 (or substantially in such a direction). Such a back-and-forth movement of the link member 2 will result in a pivotal back-and-forth movement of the pivot arm 4 around the pivot axis 5, and this in turn will lead to a corresponding back-and-forth (or up-and-down) movement of the second end 4″ of the pivot arm 4 and, finally, to an excitation of the object to be excited.

Other details of the device illustrated in FIGS. 1 and 2 will be described at a later stage.

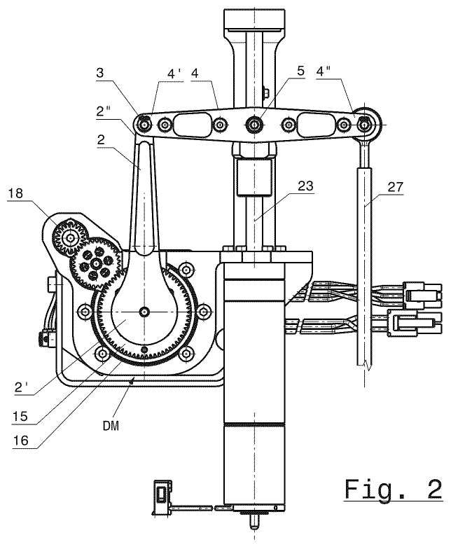

FIGS. 3 and 4 show perspective exploded views from opposite sides of the drive module DM illustrating its major parts. Only those parts which are essential for understanding the merits of the present invention will be elucidated hereafter. Basically, FIG. 3 is a perspective view from a frontal side corresponding with the view of FIGS. 1 and 2.

The device comprises a drive source, here an electric motor 6, for a drive shaft 7 with a forward end 7′. The drive shaft 7 and its forward end 7′ may be integrally connected, but also (as illustrated) may be connected by any appropriate mechanism, for example including a coupling 8. Hereinafter only reference will be made to the drive shaft 7 but this also may be its forward end 7′.

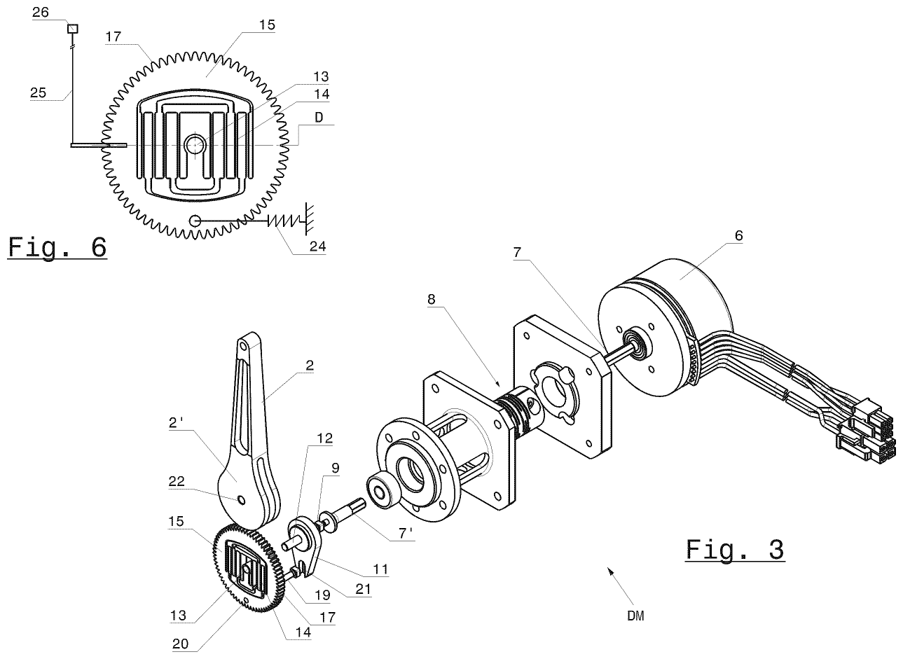

Mounted on the drive shaft is an eccentric drive pin 9 (which thus is positioned eccentrically with respect to the drive shaft 7). The drive pin 9 engages/cooperates with a drive channel 10 (not visible in FIG. 3) provided in one side of a transfer member 11 (which also is illustrated in three different views in FIGS. 5 a-c). The drive channel 10 defines a drive channel axis 10′.

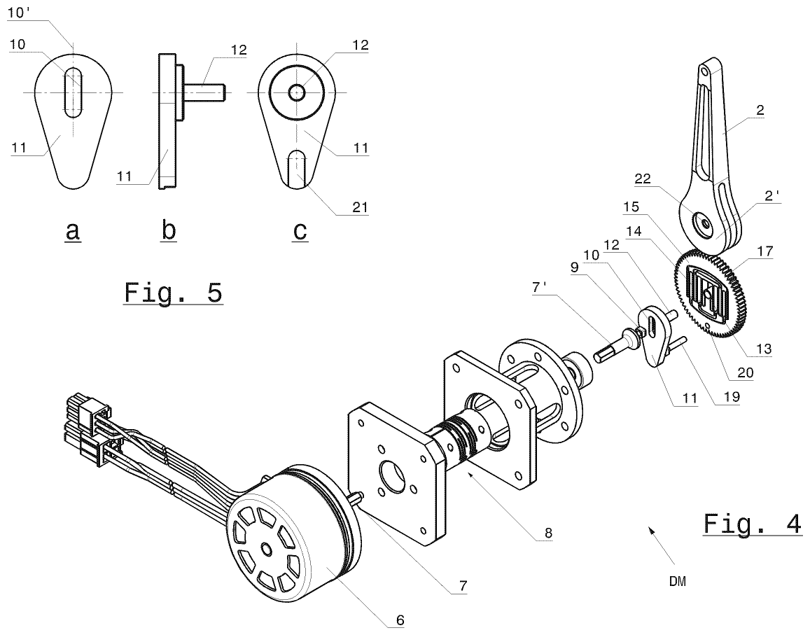

The transfer member 11 at the opposite side is provided with a protruding transfer member pin 12 which is intended to be received into a hub 13 which is carried by a spring assembly 14. As appears more clearly in FIG. 6, the spring assembly 14 is mounted in a disc member 15. The spring assembly 14 (which in the illustrated embodiment has a zig-zag shape) is designed in such a manner that the hub 13 is allowed to move back-and-forth only in one direction D, see FIG. 6 (and as such the spring assembly 14 defines a guide or guiding mechanism for the hub and, as will appear later, for the transfer member 11).

Once again referring to FIG. 2, one can see that the disc member 15 is mounted in a stationary support, or housing, 16. Specifically, the disc member 15 is mounted for a rotation (substantially around an axis which coincides with the hub 13) within the stationary support 16. For initiating such a rotation, the disc member 15 comprises an external or circumferential toothing 17 in which a drive gear 18 engages that is mounted onto the stationary support 16 and which is driven by any appropriate source, for example an electric motor (not illustrated).

A pin 19 is provided which, at a hole 20, will be mounted on the disc member 15 and which is meant to engage an elongated slot 21 provided on the transfer member 11.

FIGS. 3 and 4 finally show the link member 2 of which the (lower) first end 2′ is forked and is provided with a through-hole 22. In an assembled state of the drive module DM the forked first end 2′ of the link member 2 straddles the disc member 15 in such a manner that the through-hole 22 coincides with the hub 13, and the transfer member pin 12 extends through the through-hole 22 and the hub 13. As a result, the transfer member 11 and the link member 2 are connected to the hub and to each other. This means that a movement of the transfer member 11 as allowed by a movement of the hub 13 within the spring assembly 14 will also occur with respect to the link member 2.

As stated above, the disc member 15 can rotate within the stationary support 16. Such a rotation will be transferred to the transfer member 11 through the cooperation between the pin 19 and the elongated slot 21.

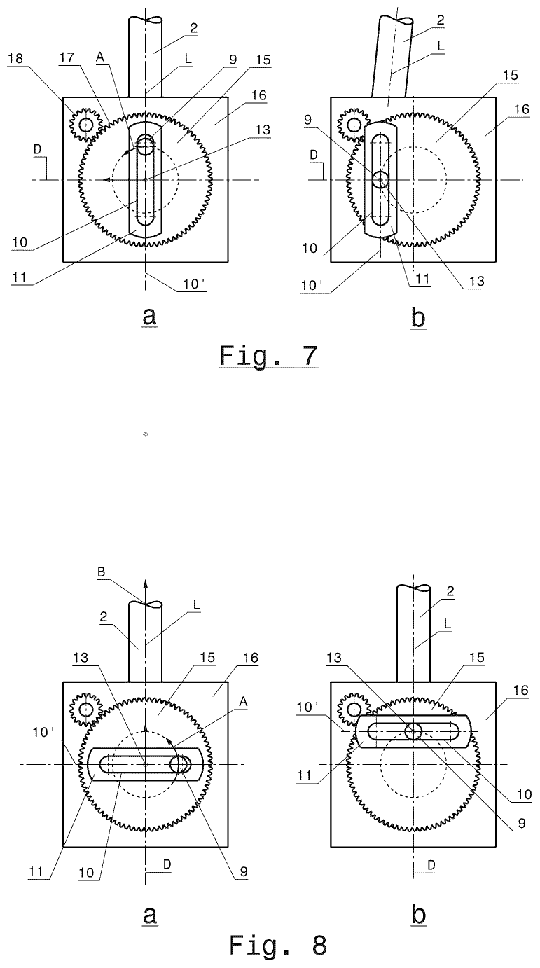

For explaining the operation of the trim excitation device, and specifically its drive module DM, reference is made to FIGS. 7 and 8 in which some parts of the drive module are illustrated schematically.

These figures illustrate the stationary support 16 having mounted therein the rotatable disc member 15. From this disc member 15 only the hub 13 is shown in detail, but it should be kept in mind that the hub 13 is mounted in the spring assembly, such that only a back-and-forth movement of the hub 13 in direction D is allowed. Further the transfer member 11 with its drive channel 10 (and the drive channel axis 10′ thereof) are shown. The figures further show the eccentric drive pin 9 that engages in the drive channel 10, part of the link member 2 with its longitudinal axis L, and (only illustrated in FIG. 7a) the drive gear 18 engaging the circumferential toothing 17 of the disc member 15.

In FIG. 7 the disc member 15 assumes a rotational position in which the drive channel axis 10′ of the drive channel 10 of the transfer member 11 extends substantially in the longitudinal direction L of the link member 2. In this rotational position the spring assembly (not illustrated) only allows a back-and-forth movement of the hub 13 (and thus of the transfer member 11 and first end 2′ of the link member 2 which are connected to the hub by pin 19) in direction D which now is perpendicularly to the longitudinal direction L of the link member 2. Thus, when the eccentric drive pin 9 is rotated around the drive shaft 7 (according to arrow A in FIG. 7a) the transfer member 11 (and hub 13 and link member 2) will move only along direction D (for example initially to the position in FIG. 7b) and no substantial longitudinal movement of the link member 2 is caused. The object, in such a position, will not be excited despite an ongoing circular movement of the eccentric drive pin 9.

In FIG. 8 the disc member 15 assumes a rotational position in which the drive channel axis 10′ of the drive channel 10 of the transfer member 11 extends substantially perpendicularly to the longitudinal direction L of the link member 2. In this rotational position the spring assembly (not illustrated) again only allows a back-and-forth movement of the hub 13 (and thus of the transfer member 11 and first end 2′ of the link member 2 which are connected to the hub by pin 19) in direction D which now coincides with (or at least extends parallel to) the longitudinal direction L of the link member 2. Thus, when the eccentric drive pin 9 is rotated around the drive shaft 7 (according to arrow A in FIG. 8a) the transfer member 11 (and hub 13 and link member 2) will move only along direction D (for example initially to the position in FIG. 8b) and a corresponding longitudinal movement of the link member 2 is caused (arrow B in FIG. 8a). The object, in such a position, will be excited during an ongoing circular movement of the eccentric drive pin 9.

In positions between the rotational positions of FIGS. 7 and 8 only a limited excitation will occur, which will increase starting from the position in FIG. 7 (no excitation) towards the position in FIG. 8 (maximum excitation).

The rotation of the disc member 15 (and thus of the transfer member 11) for changing the excitation amplitude may occur during an ongoing excitation without the need for stopping the device. The excitation frequency may be changed by changing the rotational velocity of the electric motor 6.

Referring to FIGS. 1 and 2, one can see that the pivot axis 5 of the pivot arm 4 is mounted on a linear actuator, for example an electric trim motor 23. By changing the position of the pivot axis 5 using the actuator 23 the device may be trimmed (this means that the end positions of the excitation may be changed). This also may occur without the need to stop the device.

The invention is not limited to the embodiments described which may be varied widely within the scope of the invention as defined by the appending claims. For example, referring to FIG. 6, the disc member 15 as an alternative to the toothing 17 cooperating with the drive gear 18 (as shown in FIG. 7a) may be biased towards one of its first and second rotational positions (for example by a spring 24), wherein the drive actuator includes a drive cable 25 or similar member, for example driven by a linear actuator 26, attached to the disc member 15 for moving it towards the other of its first and second rotational positions. Finally, FIG. 2 shows an output link 27 which may be used to connect the pivot arm 4 with an object to be excited.

Although the present invention has been described with reference to preferred embodiments, workers skilled in the art will recognize that changes may be made in form and detail without departing from the spirit and scope of the invention.

What is claimed is:

1. A trim excitation device, comprising:
a transfer member having a drive channel with a drive channel axis;
a rotatable drive shaft;
an eccentric drive pin mounted eccentrically on said drive shaft, which eccentric drive pin engages the drive channel of the transfer member and is movable back and forth in said drive channel in the direction of the drive channel axis;
a link member having a first end connected to the transfer member and an opposite second end, directly or indirectly, connectable to an object to be excited, and wherein the link member defines a longitudinal direction (L) extending between its first and second ends;
a guide configured to guide the transfer member back-and-forth in a direction substantially perpendicular to the drive channel axis, wherein the guide and transfer member are rotatable for assuming a desired rotational position between and including a first rotational position in which the drive channel axis extends substantially perpendicularly to the longitudinal direction (L) of the link member and the guide is configured to move the transfer member back-and-forth substantially in the longitudinal direction of the link member, and a second rotational position in which the drive channel axis extends substantially in the longitudinal direction (L) of the link member and the guide is configured to move the transfer member back-and-forth substantially perpendicularly to the longitudinal direction of the link member.

2. The trim excitation device according to claim 1, wherein the guide and the transfer member are mounted on a disc member which is mounted rotatably in a stationary support.

3. The trim excitation device according to claim 2, wherein the disc member, for assuming a desired rotational position, is driven by a drive actuator.

4. The trim excitation device according to claim 3, wherein the disc member is biased towards one of its first and second rotational positions and wherein the drive actuator includes a drive cable attached to the disc member for moving the disc member towards the other of its first and second rotational positions.

5. The trim excitation device according to claim 3, wherein the drive actuator comprises a linear actuator.

6. The trim excitation device according to claim 3, wherein the disc member is provided with a circumferential toothing and wherein the drive actuator includes a drive gear mounted on the stationary support engaging the toothing.

7. The trim excitation device according to claim 6 wherein the drive actuator comprises an electric motor having the drive gear.

8. The trim excitation device according to claim 1, wherein the guide includes a spring assembly to which the transfer member is attached, and which only allows said back-and-forth movement of the transfer member in said direction (D) substantially perpendicular to the drive channel axis.

9. The trim excitation device according to claim 8, wherein the spring assembly carries a hub and wherein the transfer member is provided with a transfer member pin engaging in the hub.

10. The trim excitation device according to claim 9, wherein the first end of the link member is connected to the transfer member pin.

11. The trim excitation device according to claim 2, wherein the disc member and transfer member are provided with an assembly of cooperating pin and elongated slot for transferring a rotational movement of the disc member to the transfer member while allowing a back-and-forth movement of the transfer member relative to the disc member.

12. The trim excitation device according to claim 11, wherein the disc member is provided with the pin, whereas the transfer member is provided with the elongated slot.

13. The trim excitation device according to claim 1, wherein the second end of the link member is connected to a first end of a pivot arm that extends non parallel to the longitudinal direction (L) of the link member and that has a second end to be connected, directly or indirectly, to the object to be excited and that pivots around a pivot axis, wherein a position of the pivot axis is adjustable.

14. The trim excitation device according to claim 13, wherein the pivot arm that extends substantially perpendicular to the longitudinal direction (L) of the link member.

15. The trim excitation device according to claim 13, wherein the position of the pivot axis of the pivot arm is adjustable in a direction substantially in parallel to the longitudinal direction (L) of the link member.

16. The trim excitation device according to claim 15 and further comprising a trim motor configured to adjust a position of the pivot axis.

17. The trim excitation device according to claim 13, wherein the second end of the pivot arm is connected to an output link to be connected to the object to be excited.

18. The trim excitation device according to claim 1, wherein the eccentricity of the eccentric drive pin is adjustable and/or wherein the eccentric drive pin is replaceable by an eccentric drive pin with a different eccentricity.

19. The trim excitation device according to claim 1, wherein the object is an aeronautical part.

20. The trim excitation device according to claim 19 wherein the aeronautical part is a rotor blade.
